(19) United States
(12) Patent Application Publication
(10) Pub. No.: US 2019/0164144 A1
(43) Pub. Date: May 30, 2019

(54) SYSTEMS AND METHODS FOR ONE-TAP BUY ORDER COMPLETION

(71) Applicant: WAITR, Inc., Lake Charles, LA (US)

(72) Inventors: Cody Hebert, Lafayette, LA (US); Rachel Rodrigue, Lafayette, LA (US); Alex Lanclos, Lafayette, LA (US); Matias Pan, Caba (AR)

(21) Appl. No.: 16/201,538

(22) Filed: Nov. 27, 2018

Related U.S. Application Data
(60) Provisional application No. 62/590,753, filed on Nov. 27, 2017.

(51) Int. Cl. G06Q 20/32; G06Q 30/06; G06Q 20/40; G06Q 20/12

(52) U.S. Cl. CPC G06Q 20/322; G06Q 20/12; G06Q 20/40; G06Q 30/0635

(57) ABSTRACT

Embodiments relate generally to computer implemented systems and computer implemented methods for confirming of contents of an order, designating a location where possession of the contents of the order will be transferred, and authorizing payment for the order, wherein payment comprises identifying (1) an amount for the order, (2) an amount for a delivery fee, and (3) an amount for a gratuity, and wherein confirming, designating, and authorizing is performed via a customer responding to only two prompts from a smart device.

### CROSS-REFERENCE TO RELATED APPLICATIONS

The present application claims priority to U.S. Provisional Patent Application Ser. No. 62/590,753 filed Nov. 27, 2017 by Cody Hebert, et al. and entitled “Systems and Methods for One-Tap Buy Order Completion” which is incorporated herein by reference as if reproduced in its entirety.

### BACKGROUND

Payments for products and services are often completed using credit cards, debit cards, checks or cash. At the same time, mobile handheld electronic devices (such as a cellular phone, smart phone, mobile handheld wireless e-mail device, personal digital assistant, portable gaming devices, tablets, etc.) may be equipped to complete purchase transactions via the device itself, a mobile internet browser accessed on the device, and/or an application stored and executed by the mobile device. Such devices may have a wireless internet connection, and a customer may wish to make payments to merchants and/or complete transactions using these mobile devices.

### SUMMARY

Disclosed herein is a computer implemented system and computer implemented method for confirming of contents of an order, designating a location where possession of the contents of the order will be transferred, and authorizing payment for the order, wherein payment comprises identifying (1) an amount for the order, (2) an amount for a delivery fee, and (3) an amount for a gratuity, and wherein confirming, designating, and authorizing is performed via a customer responding to only two prompts from the smart device.

Disclosed herein is a computer implemented system and computer implemented method for confirming of contents of an order, providing customer contact information, designating a location where possession of the contents of the order will be transferred, identifying a payment vehicle (e.g., credit card, debit card, or stored value card), and authorizing payment for the order, wherein payment comprises identifying (1) an amount for the order, (2) an amount for a delivery fee, and (3) an amount for a gratuity, and wherein confirming, designating, and authorizing is performed via a customer responding to only two prompts from the smart device.

Disclosed herein is a computer implemented system and computer implemented method for receiving, from a customer's smart device (e.g., smart phone, tablet, watch, or other computer/communication device), designation of a location where possession of contents of an order will be transferred and authorization of payment for the order, wherein payment comprises a identifying (1) an amount for the order, (2) an amount for a delivery fee, and (3) an amount for a gratuity, and wherein designation and authorization is received pursuant to a customer responding to only a single prompt from the smart device.

Disclosed herein is a computer implemented system and computer implemented method for receiving, from a customer's smart device (e.g., smart phone, tablet, watch, or other computer/communication device), provision of customer contact information, designation of a location where possession of contents of an order will be transferred, identification of payment vehicle (e.g., credit card, debit card, or stored value card), and authorization of payment for the order, wherein payment comprises a identifying (1) an amount for the order, (2) an amount for a delivery fee, and (3) an amount for a gratuity, and wherein designation and authorization is received pursuant to a customer responding to only a single prompt from the smart device.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a depiction of an order review screen according to an embodiment of the disclosure.

FIG. 2 is a depiction of a payment screen according to an embodiment of the disclosure.

FIG. 3 is a depiction of a profile screen according to an embodiment of the disclosure.

FIG. 4 is a depiction of a one-tap buy settings screen according to an embodiment of the disclosure.

FIG. 5 illustrates a smart device according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field (for example, ±10%); and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

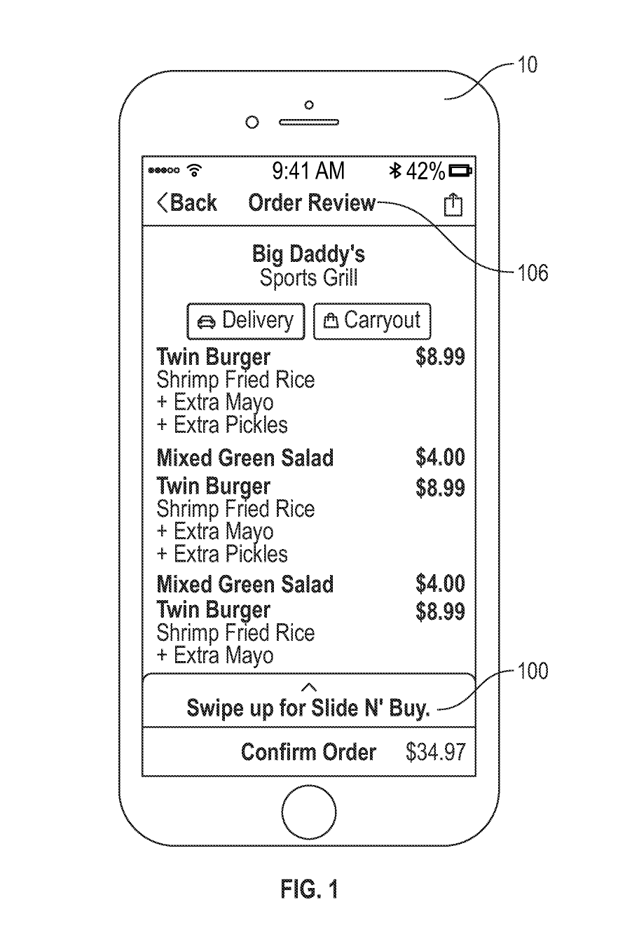

As shown in FIG. 1, using a smart device 10 (e.g., a mobile device, a mobile phone, a tablet, etc.) a customer may select a one-tap buy functionality (i.e., the ability to provide customer information data, order completion (possession) data, payment vehicle data, and payment data (amount for order, amount for delivery fee, and amount for gratuity) via response to a prompt 100 from the customer's smart device 10. An Order Review Screen 106 may comprise Delivery or Pick-Up decision buttons and/or order data (e.g., identification and price). The Order Review Screen 106 may also comprise an access one-tap buy functionality button (and/or prompt) 100, which may comprise 3-D touch, long tap, and/or indication to alert.

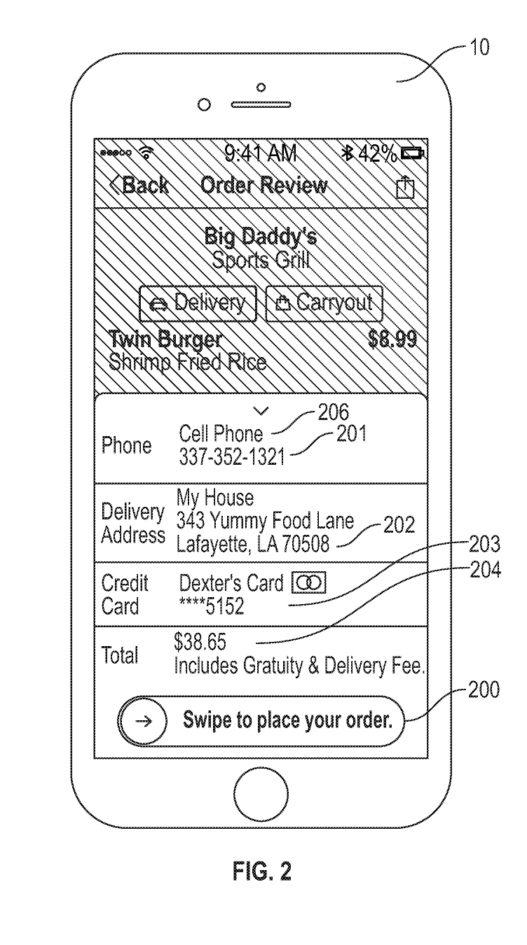

As shown in FIG. 2, after accessing the one-tap buy functionality button 100 (FIG. 1), a customer may provide customer information data 201, order completion (possession) data 202, payment vehicle data 203, and/or payment data 204 (amount for order, amount for delivery fee, and amount for gratuity) via response to a single prompt 200 from the customer's smart device 10. In some embodiments, the Payment Screen 206 may comprise a customer phone number data 201, a customer delivery address data 202, a customer payment method data 203, total cost information (menu items, delivery fee, and gratuity) 204, and/or a one-tap buy button (to place and pay for order) 200, wherein the one-tap buy button may comprise 3-D touch, long tap, and/or indication to alert.

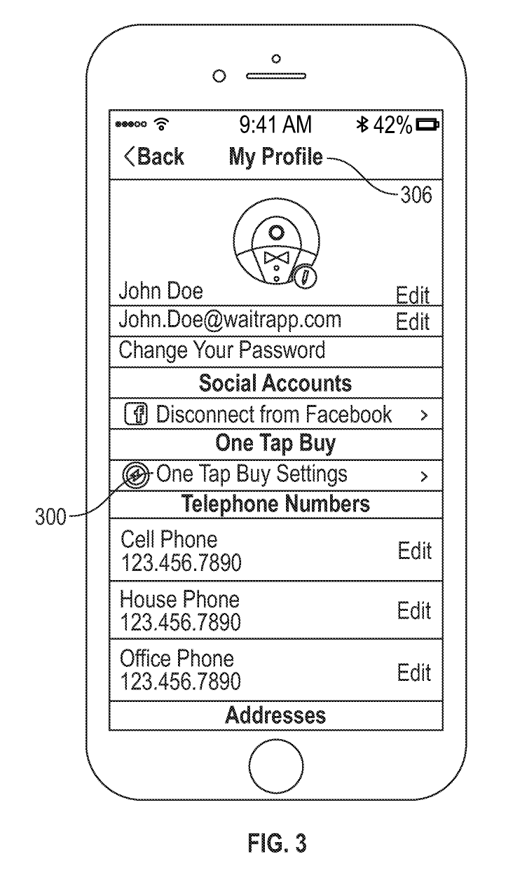

As shown in FIG. 3, in some embodiments, a Profile Screen 306 may function as a New Customer Conversion Screen configured to allow a user to add phone number data, add delivery address data, add payment vehicle data, and/or save payment and delivery data for one-tap buy functionality. In some embodiments, a New Customer Conversion Screen may appear before a user places a first order through the system to allow a user to save their information as a “profile” which may then be accessed via the Profile Screen 306. In some embodiments, a user may enter multiple phone numbers, addresses, and/or payment vehicles, which may all be saved and accessed via the Profile Screen 306. In some embodiments, a customer may select the one-tap buy functionality 300 from the “My Profile” screen 306. The Profile Screen 306 may comprise one or more section for one-tap buy functionality 300.

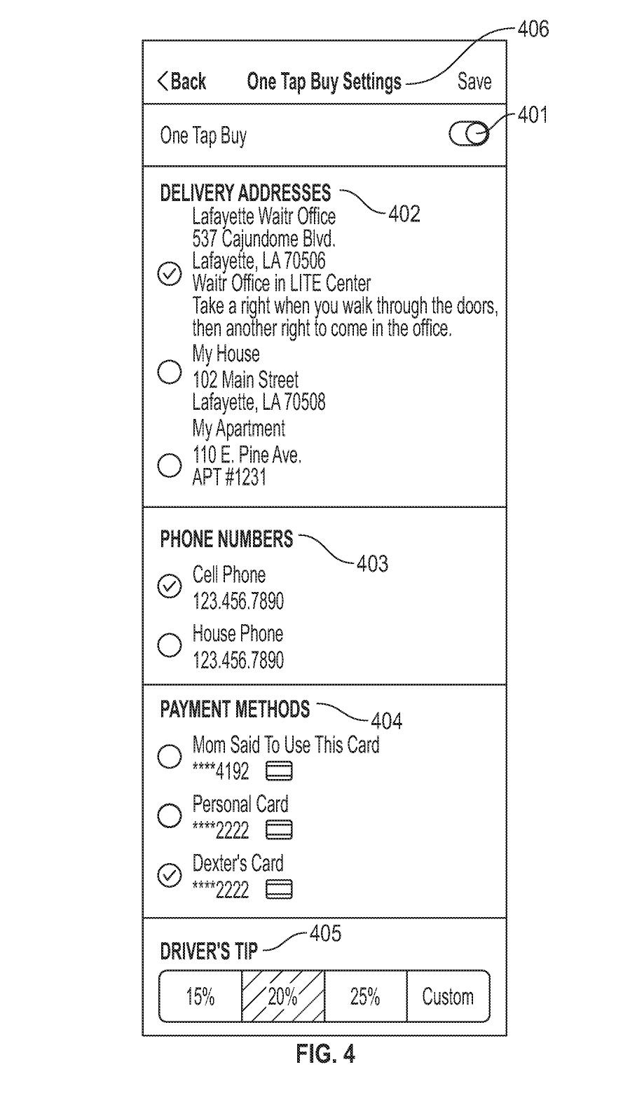

As shown in FIG. 4, when a customer accesses one-tap buy functionality settings 300 (shown in FIG. 3), a customer may enable one-tap buy functionality 401, designate a default delivery address 402, designate a default customer contact phone number 403, designate a default payment vehicle 404, and/or designate a default gratuity 405 from the one-tap buy settings screen.

In some embodiments, the default delivery address 402 may be selected from one or more addresses saved in the Profile Screen 306. In some embodiments, the user may have the option to enter a new delivery address. In some embodiments, the default customer contact phone number 403 may be selected from one or more phone numbers saved in the Profile Screen 306. In some embodiments, the user may have the option to enter a new phone number. In some embodiments, the default payment vehicle 404 may be selected from one or more payment vehicles saved in the Profile Screen 306. In some embodiments, the user may have the option to enter a new payment vehicle.

Smart devices of the disclosure may comprise a user interface configured to display an order review screen 106, a payment screen 206, a profile screen 306, and a new customer conversion screen which comprise the identified information and/or functionality 100, 106, 200-206, 300, 306, and 401-406 described above.

The disclosed systems and methods increase the viability of completing an order transaction and increase the efficiency of such an order transaction by reducing the load on a customer's smart device, reducing the lag time of the process, increasing the efficiency of the transaction system system, reducing the computer processing requirements for the transaction system, reducing the memory requirements for the transaction system, and/or reducing the bases for system crashes.

The viability of completing an order transaction may be increased via a reduction in the number of steps required in an order transaction process. A typical order process may comprise the following steps: (1) user launches app; (2) user selects restaurant; (3) user adds item(s) to cart; (4) user opens cart; (5) user taps “Confirm Order”; (6) user selects order type (e.g., Individual Order, Group Order); (7) user selects time; (8) user selects phone number; (9) user selects address; (10) user taps “Proceed to Checkout”; (11) user adjusts gratuity; (12) user taps “Place my Order”; and (13) order is sent.

As an example, embodiments of the disclosure may comprise a one-tap buy process comprising the following steps: (1) user launches app; (2) user selects restaurant; (3) user adds item(s) to cart; (4) user opens cart; (5) user swipes up (to select one-tap buy option); (6) user swipes right (to activate one-tap buy functionality); and (7) order is sent. The elimination of the typical steps of selecting an order type, selecting a time, selecting a phone number, selecting an address, and/or adjusting the gratuity increases the probability that an order will remain viable to completion.

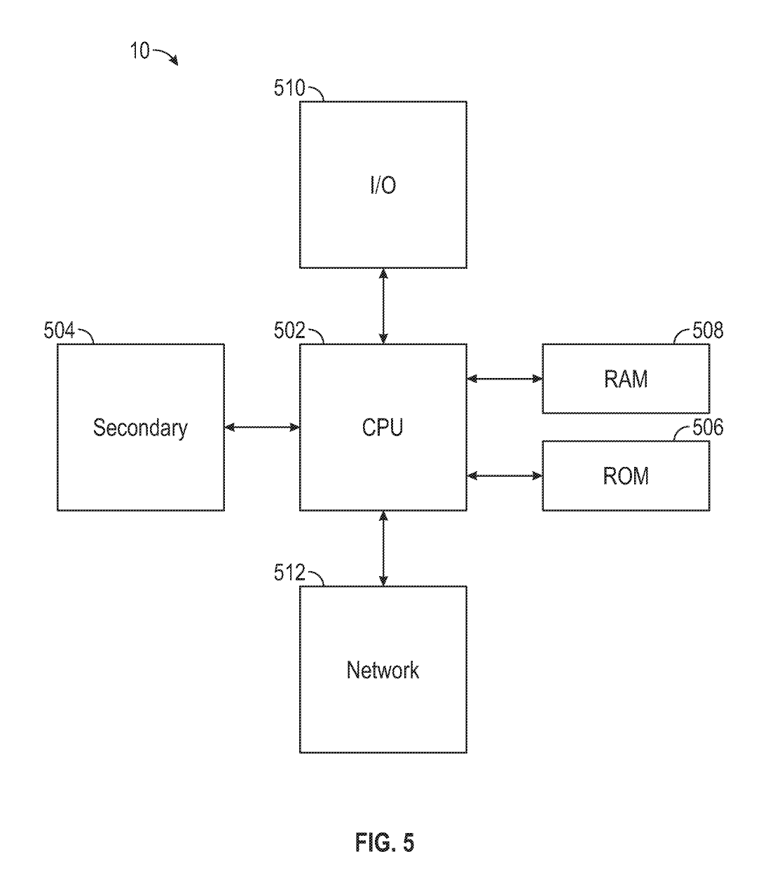

The transaction system comprises and is implemented via one or more particular machines generally comprising sufficient processing power, memory resources, and network throughput capability to handle the necessary workload placed upon it. FIG. 5 illustrates an embodiment of the smart device 10 suitably configured to implement all, or a portion of, one or more embodiments disclosed herein. The smart device 10 includes a processor 502 (which may be referred to as a central processor unit or CPU) that is in communication with memory devices including secondary storage 504, read only memory (ROM) 506, random access memory (RAM) 508, input/output (I/O) devices 510, and network connectivity devices 512. The processor 502 may be implemented as one or more CPU chips.

It is understood that by programming and/or loading executable instructions onto the smart device 10, at least one of the CPU 502, the RAM 508, and the ROM 506 are changed, transforming the smart device 10 in part into a particular machine (and/or a special-purpose computer) having the particular, novel functionalities disclosed herein and thereby enabled to perform the novel and nonobvious methods, tasks, processes, and steps disclosed herein; thus, the smart device 10 does not constitute and cannot be implemented via a general purpose machine. It is fundamental to the electrical engineering and software engineering arts that a particular functionality that can be implemented by loading executable software into a computer (or a component thereof) and, likewise, that a particular functionality that can be implemented via hardware utilizing well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine (and/or special-purpose computer).

In some embodiments, the secondary storage 504 may be comprised of one or more disk drives or tape drives, for example, which may be used for non-volatile storage of data and as an over-flow data storage device if RAM 508 is not large enough to hold all working data. Secondary storage 504 may be used to store programs which are loaded into RAM 508 when such programs are selected for execution. The ROM 506 is used to store instructions and perhaps data which are read during program execution. ROM 506 is a non-volatile memory device which typically has a small memory capacity relative to the larger memory capacity of secondary storage 504. The RAM 508 is used to store volatile data and perhaps to store instructions. Access to both ROM 506 and RAM 508 is typically faster than to secondary storage 504. The secondary storage 504, the RAM 508, and/or the ROM 506 may be referred to in some contexts as computer readable storage media and/or non-transitory computer readable media.

In some embodiments, the I/O devices 510 may include printers, video monitors, liquid crystal displays (LCDs), touch screen displays, keyboards, keypads, switches, dials, mice, track balls, voice recognizers, card readers, paper tape readers, or other well-known input devices.

In some embodiments, the network connectivity devices 512 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 512 may enable the processor 502 to communicate with the Internet or one or more intranets. With such a network connection, it is contemplated that the processor 502 might receive information from the network or might output information to the network in the course of performing the above-described method steps. Such information, which is often represented as a sequence of instructions to be executed using processor 502, may be received from and outputted to the network, for example, in the form of a computer data signal embodied in a carrier wave.

Such information, which may include data or instructions to be executed via the processor 502 may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 502 executes instructions, codes, computer programs, scripts which it accesses from a hard disk, a floppy disk, an optical disk (these various disk-based systems may all be considered secondary storage 504), ROM 506, RAM 508, or the network connectivity devices 512. While only one processor 502 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 504, for example, hard drives, floppy disks, optical disks, and/or other device, the ROM 506, and/or the RAM 508 may be referred to in some contexts as non-transitory instructions and/or non-transitory information.

In some embodiments, the smart device 10 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the smart device 10 to provide the functionality of a number of servers that is not directly bound to the number of computers in the smart device 10. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In some embodiments, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer-usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the smart device 10, at least portions of the contents of the computer program product to the secondary storage 504, to the ROM 506, to the RAM 508, and/or to other non-volatile memory and volatile memory of the smart device 10. The processor 502 may process the executable instructions and/or data structures in part by directly accessing the computer program product, for example by reading from a CD-ROM disk inserted into a disk drive peripheral of the smart device 10. Alternatively, the processor 502 may process the executable instructions and/or data structures by remotely accessing the computer program product, for example by downloading the executable instructions and/or data structures from a remote server through the network connectivity devices 512. The computer program product may comprise instructions that promote the loading and/or copying of data, data structures, files, and/or executable instructions to the secondary storage 504, to the ROM 506, to the RAM 508, and/or to other non-volatile memory and volatile memory of the smart device 10.

In some contexts, the secondary storage 504, the ROM 506, and the RAM 508 may be referred to as a non-transitory computer readable medium or a computer readable storage media. A dynamic RAM embodiment of the RAM 508, likewise, may be referred to as a non-transitory computer readable medium in that while the dynamic RAM receives electrical power and is operated in accordance with its design, for example during a period of time during which the smart device 10 is turned on and operational, the dynamic RAM stores information that is written to it. Similarly, the processor 502 may comprise an internal RAM, an internal ROM, a cache memory, and/or other internal non-transitory storage blocks, sections, or components that may be referred to in some contexts as non-transitory computer readable media or computer readable storage media.

Having described various devices and methods herein, exemplary embodiments or aspects can include, but are not limited to:

In a first embodiment, a computer implemented method for facilitating a purchase transaction performed by an order processing computer having a processor and a memory storing instructions which, when executed by the processor, causes the order processing computer to perform the method, which may comprise receiving, from a customer's smart device, designation of a location where possession of contents of an order will be transferred; and receiving, from a customer's smart device, authorization of payment for the order, wherein payment comprises identifying (1) an amount for the order, (2) an amount for a delivery fee, and (3) an amount for a gratuity, and wherein designation and authorization is received pursuant to a customer responding to only a single prompt from the smart device.

A second embodiment can include the method of the first embodiment, wherein the designation of the location where possession of contents of the order will be transferred and the authorization of payment for the order is received in a single communication transmission from the smart device.

A third embodiment can include the method of the first or second embodiments, further comprising receiving, from a customer's smart device, provision of customer identification data.

A fourth embodiment can include the method of any of the first through third embodiments, further comprising receiving, from a customer's smart device, identification of a payment vehicle.

A fifth embodiment can include the method of any of the first through fourth embodiments, further comprising designating one-tap buy settings associated with the customer that include one or more of a default delivery address, a default customer contact phone number, a default payment vehicle, and/or a default gratuity.

In a sixth embodiment, a system may comprise a processor; and a memory storing instructions which, when executed by the processor, cause the processor to perform operations comprising receive, from a customer's smart device, designation of a location where possession of contents of an order will be transferred; and receive, from a customer's smart device, authorization of payment for the order, wherein payment comprises identifying (1) an amount for the order, (2) an amount for a delivery fee, and (3) an amount for a gratuity, and wherein designation and authorization is received pursuant to a customer responding to only a single prompt from the smart device.

A seventh embodiment can include the system of the sixth embodiment, wherein the designation of the location where possession of contents of the order will be transferred and the authorization of payment for the order is received in a single communication transmission from the smart device.

An eighth embodiment can include the system of the sixth or seventh embodiments, wherein the processor is caused to perform operations further comprising receive, from a customer's smart device, provision of customer identification data.

A ninth embodiment can include the system of any of the sixth through eighth embodiment, wherein the processor is caused to perform operations further comprising receive, from a customer's smart device, identification of a payment vehicle.

A tenth embodiment can include the system of any of the sixth through ninth embodiment, wherein the processor is caused to perform operations further comprising designate one-tap buy settings associated with the customer that include one or more of a default delivery address, a default customer contact phone number, a default payment vehicle, and/or a default gratuity.

An eleventh embodiment can include the system of the tenth embodiment, wherein the processor is caused to perform operations further comprising save one or more delivery addresses to a profile associated with the customer, and wherein the default delivery address is selected from the one or more saved addresses.

A twelfth embodiment can include the system of the tenth or eleventh embodiments, wherein the processor is caused to perform operations further comprising save one or more customer contact phone number to a profile associated with the customer, and wherein the default customer contact phone number is selected from the one or more saved customer contact phone number.

A thirteenth embodiment can include the system of any of the tenth through twelfth embodiments, wherein the processor is caused to perform operations further comprising save one or more payment vehicle to a profile associated with the customer, and wherein the default payment vehicle is selected from the one or more saved payment vehicle.

In a fourteenth embodiment, a computer implemented method for facilitating a purchase transaction performed by customer's smart device having a processor and a memory storing instructions which, when executed by the processor, causes the smart device to perform the method, which may comprise confirming contents of an order; designating a location where possession of the contents of the order will be transferred; and authorizing payment for the order, wherein payment comprises identifying (1) an amount for the order, (2) an amount for a delivery fee, and (3) an amount for a gratuity, and wherein confirming, designating, and authorizing is pursuant to a customer responding to only two prompts from the smart device.

A fifteenth embodiment can include the method of the fourteenth embodiment, further comprising providing customer identification data.

A sixteenth embodiment can include the method of the fourteenth or fifteenth embodiment, further comprising identifying a payment vehicle.

A seventeenth embodiment can include the method of any of the fourteenth through sixteenth embodiments, further comprising designating one-tap buy settings associated with the customer that include one or more of a default delivery address, a default customer contact phone number, a default payment vehicle, and/or a default gratuity.

An eighteenth embodiment can include the method of the seventeenth embodiment, further comprising saving one or more delivery addresses to a profile associated with the customer, and wherein the default delivery address is selected from the one or more saved addresses.

A nineteenth embodiment can include the method of the seventeenth or eighteenth embodiments, further comprising saving one or more customer contact phone number to a profile associated with the customer, and wherein the default customer contact phone number is selected from the one or more saved customer contact phone number.

A twentieth embodiment can include the method of any of the seventeenth through nineteenth embodiments, further comprising saving one or more payment vehicle to a profile associated with the customer, and wherein the default payment vehicle is selected from the one or more saved payment vehicle.

What is claimed is:

1. A computer implemented method for facilitating a purchase transaction performed by an order processing computer having a processor and a memory storing instructions which, when executed by the processor, causes the order processing computer to perform the method comprising:
receiving, from a customer's smart device, designation of a location where possession of contents of an order will be transferred; and
receiving, from a customer's smart device, authorization of payment for the order, wherein payment comprises identifying (1) an amount for the order, (2) an amount for a delivery fee, and (3) an amount for a gratuity, and wherein designation and authorization is received pursuant to a customer responding to only a single prompt from the smart device.

2. The computer implemented method of claim 1, wherein the designation of the location where possession of contents of the order will be transferred and the authorization of payment for the order is received in a single communication transmission from the smart device.

3. The computer implemented method of claim 1, further comprising receiving, from a customer's smart device, provision of customer identification data.

4. The computer implemented method of claim 1, further comprising receiving, from a customer's smart device, identification of a payment vehicle.

5. The computer implemented method of claim 1, further comprising designating one-tap buy settings associated with the customer that include one or more of a default delivery address, a default customer contact phone number, a default payment vehicle, and/or a default gratuity.

6. A system comprising:
a processor; and
a memory storing instructions which, when executed by the processor, cause the processor to perform operations comprising:
receive, from a customer's smart device, designation of a location where possession of contents of an order will be transferred; and
receive, from a customer's smart device, authorization of payment for the order, wherein payment comprises identifying (1) an amount for the order, (2) an amount for a delivery fee, and (3) an amount for a gratuity, and wherein designation and authorization is received pursuant to a customer responding to only a single prompt from the smart device.

7. The system of claim 6, wherein the designation of the location where possession of contents of the order will be transferred and the authorization of payment for the order is received in a single communication transmission from the smart device.

8. The system of claim 6, wherein the processor is caused to perform operations further comprising receive, from a customer's smart device, provision of customer identification data.

9. The system of claim 6, wherein the processor is caused to perform operations further comprising receive, from a customer's smart device, identification of a payment vehicle.

10. The system of claim 6, wherein the processor is caused to perform operations further comprising designate one-tap buy settings associated with the customer that include one or more of a default delivery address, a default customer contact phone number, a default payment vehicle, and/or a default gratuity.

11. The system of claim 10, wherein the processor is caused to perform operations further comprising save one or more delivery addresses to a profile associated with the customer, and wherein the default delivery address is selected from the one or more saved addresses.

12. The system of claim 10, wherein the processor is caused to perform operations further comprising save one or more customer contact phone number to a profile associated with the customer, and wherein the default customer contact phone number is selected from the one or more saved customer contact phone number.

13. The system of claim 10, wherein the processor is caused to perform operations further comprising save one or more payment vehicle to a profile associated with the customer, and wherein the default payment vehicle is selected from the one or more saved payment vehicle.

14. A computer implemented method for facilitating a purchase transaction performed by customer's smart device having a processor and a memory storing instructions which, when executed by the processor, causes the smart device to perform the method comprising:
confirming contents of an order;
designating a location where possession of the contents of the order will be transferred; and
authorizing payment for the order, wherein payment comprises identifying (1) an amount for the order, (2) an amount for a delivery fee, and (3) an amount for a gratuity, and wherein confirming, designating, and authorizing is pursuant to a customer responding to only two prompts from the smart device.

15. The computer implemented method of claim 14, further comprising providing customer identification data.

16. The computer implemented method of claim 14, further comprising identifying a payment vehicle.

17. The computer implemented method of claim 14, further comprising designating one-tap buy settings associated with the customer that include one or more of a default delivery address, a default customer contact phone number, a default payment vehicle, and/or a default gratuity.

18. The computer implemented method of claim 17, further comprising saving one or more delivery addresses to a profile associated with the customer, and wherein the default delivery address is selected from the one or more saved addresses.

19. The computer implemented method of claim 17, further comprising saving one or more customer contact phone number to a profile associated with the customer, and wherein the default customer contact phone number is selected from the one or more saved customer contact phone number.

20. The computer implemented method of claim 17, further comprising saving one or more payment vehicle to a profile associated with the customer, and wherein the default payment vehicle is selected from the one or more saved payment vehicle.
